(19) United States
(12) Patent Application Publication
(10) Pub. No.: US 2023/0146618 A1
(43) Pub. Date: May 11, 2023

(54) POP-UP SEABED SEISMIC NODE

(71) Applicant: PXGEO UK Limited, Bristol (GB)

(72) Inventors: Jason Jurok, Calgary (CA); Martin John Hartland, Katy, TX (US); Nishan Ragoonanan, Houston, TX (US); Ilya Martinalbo, Houston, TX (US)

(73) Assignee: PXGEO UK Limited, Bristol (GB)

(21) Appl. No.: 17/982,786

(22) Filed: Nov. 8, 2022

Related U.S. Application Data
(60) Provisional application No. 63/277,907, filed on Nov. 10, 2021.

(51) Int. Cl. G01V 1/38

(52) U.S. Cl. CPC G01V 1/3852; G01V 2210/1427

(57) ABSTRACT

An autonomous seismic node is configured for free-fall from a water surface to the seabed and is capable of rising from the seabed on its own. The seismic node is positively buoyant in water and is substantially tubular in shape, with a length to a diameter ratio of 4:1 or greater. The node comprises a lower section and an upper section, each of which is inserted into an end of a tubular housing. The lower section has a lower end cap assembly with a release mechanism and the upper section has an upper end cap assembly with a plurality of electronic components and a detachable lifting cage. The seismic node may be coupled to a detachable anchor weight or seabed coupling device to assist in free fall to the seabed, and when detached after seismic recording is performed, allows the seismic node to rise to the water surface.

### PRIORITY

This application claims priority to U.S. provisional patent application No. 63/277,907, filed on Nov. 10, 2021, the entire contents of which is incorporated herein by reference.

### BACKGROUND OF THE INVENTION

### Field of the Invention

This invention relates to marine seismic systems and more particularly relates to autonomous seismic nodes that may be deployed on the seabed.

### Description of the Related Art

Marine seismic data acquisition and processing generates a profile (image) of a geophysical structure under the seafloor. Reflection seismology is a method of geophysical exploration to determine the properties of the Earth's subsurface, which is especially helpful in determining an accurate location of oil and gas reservoirs or any targeted features. Marine reflection seismology is based on using a controlled source of energy (typically acoustic energy) that sends the energy through seawater and subsurface geologic formations. The transmitted acoustic energy propagates downwardly through the subsurface as acoustic waves, also referred to as seismic waves or signals. By measuring the time it takes for the reflections or refractions to come back to seismic receivers (also known as seismic data recorders or nodes), it is possible to evaluate the depth of features causing such reflections. These features may be associated with subterranean hydrocarbon deposits or other geological structures of interest.

In general, either ocean bottom cables (OBC) or ocean bottom nodes (OBN) are placed on the seabed. For OBC systems, a cable is placed on the seabed by a surface vessel and may include a large number of seismic sensors, typically connected every 25 or 50 meters into the cable. The cable provides support to the sensors, and acts as a transmission medium for power to the sensors and data received from the sensors. One such commercial system is offered by Sercel under the name SeaRay®. Regarding OBN systems, and as compared to seismic streamers and OBC systems, OBN systems have nodes that are discrete, autonomous units (no direct connection to other nodes or to the marine vessel) where data is stored and recorded during a seismic survey. One such OBN system is offered by the Applicant under the name Manta®. See, e.g., U.S. Pat. No. 9,523,780. For OBN systems, seismic data recorders are placed directly on the ocean bottom by a variety of mechanisms, including by the use of one or more of Autonomous Underwater Vehicles (AUVs), Remotely Operated Vehicles (ROVs), by dropping or diving from a surface or subsurface vessel, or by attaching autonomous nodes to a cable that is deployed behind a marine vessel. See, e.g., U.S. Pat. No. 9,784,873. In other embodiments, the seismic node may be integrated with an AUV. One such OBN system is offered by the Applicant under the name Spicerack®. See, e.g., U.S. Pat. Nos. 9,873,496; 10,322,783; 10,543,892.

Autonomous ocean bottom seismic nodes are independent seismometers, and in a typical application they are self-contained units comprising a housing, frame, skeleton, or shell that includes various internal components such as geophone and hydrophone sensors, a data recording unit, a reference clock for time synchronization, and a power source. The power sources are typically battery-powered, and in some instances the batteries are rechargeable. In operation, the nodes remain on the seafloor for an extended period of time. Once the data recorders are retrieved, the data is downloaded and batteries may be replaced or recharged in preparation of the next deployment. Various designs of ocean bottom autonomous nodes are well known in the art, and may have any number of configurations. Other prior art systems include a deployment rope/cable with integral node casings or housings for receiving autonomous seismic nodes or data recorders. Traditional prior art nodes are often made of tubes of various shapes that are joined and/or coupled together with cables, which can be vulnerable to handling and assembly errors. Other prior nodes can be made of spherical glass pressure housings that need additional protection and are less than ideal for storage, handling, and stability when on the seabed. Other prior are nodes are expensive to manufacture and difficult to deploy and couple to the seabed.

The referenced shortcomings are not intended to be exhaustive, but rather are among many that tend to impair the effectiveness of previously known techniques in seafloor deployment systems; however, those mentioned here are sufficient to demonstrate that the methodologies appearing in the art have not been satisfactory and that a significant need exists for the systems, apparatuses, and techniques described and claimed in this disclosure.

A need exists for an improved autonomous seismic node design for automated node deployment, recovery, handing, and storage. A need exists for a node that provides increased operational parameters, increased seabed coupling, and more versatile deployment options. A need exists for a seismic node design that can be mass-produced in a cost-effective manner. A need exists for a node that can be used in multiple deployment configurations. A need exists for a seismic node design that enables large numbers of nodes to be operated in the field.

### SUMMARY OF THE INVENTION

An autonomous seismic node that is configured for free-fall from the water surface to the seabed and that is capable of popping up and/or rising from the seabed to the water surface on its own. The seismic node is substantially cylindrical and/or tubular in shape and is positively buoyant in water. The node comprises an upper end cap assembly and a lower end cap assembly, each of which is inserted into an end of the tubular housing. The seismic node may be coupled to an anchor weight system to assist in free fall to the seabed, or may be coupled to a seabed coupling device that allows for traditional seabed seismic recording. The anchor weight system may comprise a first part coupled to the seismic node via a tether, and a second part directly attached to the seismic node, each of which may be separately released from the seismic node. The seismic node is positively buoyant, and may be coupled to a detachable/removable anchor weight that provides an overall negative buoyancy to the node and assists in free fall of the seismic node to the seabed. The detachable weight system may be comprised of two separately detachable parts—a first part that comprises a heavy anchor weight and a second part that is not as dense and which gives the seismic node approximately neutral buoyancy. The lower end cap assembly may contain the seismic sensors and battery cells, and the upper end cap assembly may contain any acoustic devices. A plurality of seismic nodes may be dropped from a surface vessel into a body of water, and free-fall to the seabed. After seismic recording is performed as is known in the art, the anchor weight and/or seabed coupling device may be detached, thereby causing the seismic node to rise to the water surface based on the positive buoyancy of the device.

An autonomous seismic node is configured for free-fall from a water surface to the seabed and is capable of rising from the seabed on its own. The seismic node is positively buoyant in water and is substantially tubular in shape, with a length to a diameter ratio of 4:1 or greater. The node comprises a lower section and an upper section, each of which is inserted into an end of a tubular housing. The lower section has a lower end cap assembly with a release mechanism and the upper section has an upper end cap assembly with a plurality of electronic components and a detachable lifting cage. The seismic node may be coupled to a detachable anchor weight or seabed coupling device to assist in free fall to the seabed, and when detached after seismic recording is performed, allows the seismic node to rise to the water surface.

Disclosed is an autonomous seismic node for deployment to the seabed, that comprises a pressurized node housing, wherein at least one seismic sensor, at least one data recording unit, and at least one clock are located within the pressurized node housing, and wherein the node housing is substantially tubular and has a length to a diameter ratio of 4:1 or greater. The node housing may have a length to diameter ratio of 8:1 or greater. The node housing may have a center of gravity and a center of buoyancy, wherein the center of gravity is below the center of buoyancy. The node housing may have an internal buoyancy chamber, such that the node housing is positively buoyant. The buoyancy chamber may be empty space or may be buoyant materials that are less dense than water. The seismic node may comprise a detachable lifting cage coupled to an upper section of the node housing.

The seismic node may have a node housing that comprises an upper section, a lower section, an upper end cap assembly coupled to the upper section, and a lower end cap assembly coupled to the lower section. The end cap assemblies may be coupled to the upper and lower sections of the node housing via a plurality of clips. Each of clips may be substantially flat and have wedge and/or dog-boned shapes. A first plurality of clips may attach the upper end cap assembly to the node housing and a second plurality of clips may attach the lower end cap assembly to the node housing. Each of the first plurality of clip may fit within a first plurality of corresponding recesses on the upper section and the upper end cap assembly and the second plurality of clip may fit within a second plurality of corresponding recesses on the lower section and the lower end cap assembly. The upper end cap assembly may have a hydrophone, an acoustic transducer, a satellite transducer, and an electronic connector. The lower cap assembly may be comprise a release mechanism, which may be coupled to a tether, anchor weight, or seabed coupling device that can be detached from the seismic node. The lower cap assembly may comprise and/or be coupled to a plurality of battery cells and a plurality of seismic sensors within the node housing. The upper and lower end cap assemblies may comprise a polymer material.

The seismic node may further comprise at least one anchor weight coupled to the node housing that is configured to be released from the seismic node by an acoustic signal. The seismic node housing may be positively buoyant in water. The at least one anchor weight may be coupled to the node housing via a flexible tether or directly attached to the bottom of the seismic node. The at least one anchor weight may comprise a seabed coupling device. The at least one anchor weight may comprise a first anchor weight and a second anchor weight, such that the first anchor weight is directly attached to the node housing and the second anchor weight is coupled to the first anchor weight via a tether, wherein the first anchor weight is positioned between the seismic node and the second anchor weight. The first and second anchor weights can be released from the seismic node by an acoustic signal by the use of a release mechanism assembly on the lower end cap of the seismic node. The second anchor weight may be coupled to the seabed when the seismic node is near the bottom of the ocean and has fully descended. A combination of the seismic node housing and the at least one anchor weight may be negatively buoyant in water. A combination of the seismic node and the first anchor weight may be approximately neutrally buoyant in water. A combination of the seismic node, the first anchor weight, and the second anchor weight may be negatively buoyant in water. The first and second anchor weights may be different weights, such that the second anchor weight is heavier than the first anchor weight.

The seismic node comprises a positively buoyant section and a negatively buoyant section, wherein the negatively buoyant section is removably detached from the positively buoyant section. The negatively buoyant section may comprise an anchor weight or a seabed coupling device. The positively buoyant section may comprise an internal buoyancy chamber of the seismic node, or may comprise an external buoyancy jacket or sleeve. The seismic node may comprise or be coupled to a flotation jacket configured to substantially surround the seismic node housing. The combination of the seismic node housing and the flotation jacket may be positively buoyant in water.

Disclosed is an autonomous seismic node for deployment to the seabed, comprising a pressurized node housing, wherein at least one seismic sensor, at least one data recording unit, and at least one clock are located within the pressurized node housing, and an anchor weight removably attached to a lower section of the node housing. The node housing may be substantially tubular and/or cylindrical and has a length to a diameter ratio of 4:1 or greater. An upper section and a lower section may be inserted into the node housing. An anchor weight may be coupled to the node housing via a flexible tether. The anchor weight may comprise a seabed coupling device that is directly coupled to the node housing. The seabed coupling device may comprise one or more of a plate, a tripod, a tripod base, one or more ribbed spears, and/or an open-ended pipe base. The anchor weight may comprise a biodegradable material. The anchor weight may be configured to be released from the seismic node by an acoustic signal.

Disclosed is a method for deploying an autonomous seismic node to the seabed, comprising providing a seismic node on a back deck of a marine vessel, coupling an anchor weight to the node housing while the seismic node is on the back deck of the marine vessel, and deploying the seismic node with the coupled anchor weight from the surface vessel to the bottom of the ocean. The method may further comprise coupling the anchor weight to the bottom of the ocean. The method may further comprise retrieving the node housing from the bottom of the ocean. The method may further comprise releasing the anchor weight from the node housing based on an acoustic signal and surfacing the node housing near a surface of a body of water. The method may further comprise recording seismic signals on the ocean bottom. The seismic node may comprise a pressurized node housing, wherein at least one seismic sensor, at least one data recording unit, and at least one clock are located within the pressurized node housing, wherein the node housing is substantially tubular and has a length to a diameter ratio of 4:1 or greater.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1A is a schematic diagram illustrating one embodiment of an autonomous seismic node according to the present disclosure.

FIG. 1B is a schematic diagram illustrating another embodiment of an autonomous seismic node according to the present disclosure.

FIGS. 2A-2C illustrate perspective views of one embodiment of an autonomous seismic node according to the present disclosure.

FIGS. 3A-3B illustrate an internal configuration of one embodiment of the autonomous seismic node from FIGS. 2A-2C.

FIGS. 4A-4B illustrate one embodiment of an autonomous seismic node coupled to a seabed coupling device according to the present disclosure.

FIGS. 5A-5C illustrate one embodiment of an autonomous seismic node coupled to a seabed coupling device according to the present disclosure.

FIGS. 6A-6B illustrate one embodiment of an autonomous seismic node coupled to a seabed coupling device according to the present disclosure.

FIGS. 7A-7D illustrate one embodiment of an autonomous seismic node according to the present disclosure.

FIGS. 8A-8D illustrate one embodiment of an upper end of the autonomous seismic node of FIG. 7A.

FIGS. 9A-9G illustrate one embodiment of an upper end of the autonomous seismic node of FIG. 7A.

FIGS. 10A-10F illustrate one embodiment of a lower end of the autonomous seismic node of FIG. 7A.

FIGS. 11A-11B illustrate one embodiment of an autonomous seismic node with a flotation jacket according to the present disclosure.

FIGS. 12A-12F illustrate multiple views of one embodiment of the autonomous seismic node from FIGS. 11A-11B.

FIG. 13 illustrates one embodiment of a storage container for a plurality of autonomous seismic nodes according to one embodiment of the present disclosure.

### DETAILED DESCRIPTION

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure. The following detailed description does not limit the invention.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures, or characteristics may be combined in any suitable manner in one or more embodiments.

### Overview

Disclosed is an autonomous seismic node that, in one embodiment, is designed for free-fall from the water surface to the seabed and that is capable of popping up and/or rising from the seabed to the water surface on its own. In one embodiment, the seismic node is substantially cylindrical and/or tubular in shape. The seismic node may have a length to a diameter ratio of 4:1 or greater. The seismic node comprises a positively buoyant section and a negatively buoyant section, wherein the negatively buoyant section is removably detached from the positively buoyant section. The seismic node may be coupled to one or more anchor weights. The anchor weight may be directly coupled to the seismic node or coupled to the seismic node via a flexible tether. In other embodiments, the anchor weight may be a seabed coupling device that allows for traditional seabed seismic recording. The seismic node comprises one or more seismic sensors that are configured to record seismic signals while on the ocean floor, a digital recording device, a clock, and one or more power sources (such as battery cells). The seismic node may also have a radio or satellite transponder with GPS positioning capability and any necessary acoustic communication devices, such as an integrated USBL. In one embodiment, the seismic node comprises an upper end cap assembly and a lower end cap assembly, each of which is inserted into the tubular housing. The lower end cap assembly may be coupled to the geophones and battery cells, and the upper end cap assembly may be coupled to any acoustic devices. A buoyancy chamber may be located between the upper and lower end cap assemblies to provide positive buoyancy to the seismic node.

In one embodiment, a plurality of seismic nodes may be dropped from a surface vessel into a body of water, and free-fall to the bottom of the water, such as the seabed. The combination of the seismic node and the coupled anchor weight is overall negatively buoyant, such that the seismic node sinks to the ocean bottom. On the seafloor the position and orientation of the seismic node must be known, and in one embodiment the location of each seismic node may be determined by USBL position and any necessary acoustic transducers. After seismic recording is performed, as is known in the art, the anchor weight and/or seabed coupling device may be detached, thereby causing the seismic node to rise to the water surface based on the overall positive buoyancy of the device without the anchor weight. In one embodiment, the seismic node is configured to receive an acoustic command to autonomously return to the surface at the end of the survey and release any anchor weight for the seismic node to rise. In one embodiment, the seismic node does not have a separate propulsion system (and is thus not an AUV), and merely falls to and rises from the seabed based on its own static buoyancy.

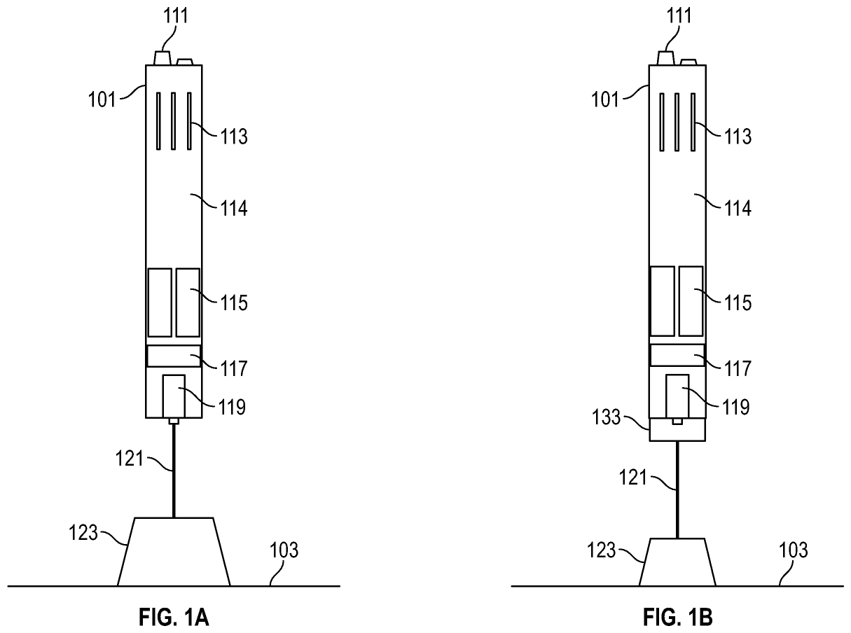

In one embodiment, the seismic node is designed for rapid descent and minimal drift during descent to the seabed due to lateral current forces. The design and configuration of the seismic node is ideal for storage and transportation. In one embodiment (see FIG. 1A), the seismic node is positively buoyant, and may be coupled to a detachable/removable anchor weight that provides an overall negative buoyancy to the node and assists in free fall of the seismic node to the seabed. In other embodiments (see FIG. 1B), the detachable weight system may be comprised of two separate parts—a first part that comprises a heavy anchor weight and rests on the seabed and a second part directly attached to the seismic node that is not as dense and which gives the seismic node approximately neutral buoyancy in the water. In both embodiments, a tether couples the seabed anchor to a detachable device (such as a release assembly mechanism) on the seismic node housing.

FIG. 1A is a schematic diagram illustrating one embodiment of an autonomous seismic node according to the present disclosure. As illustrated, the shape of the seismic node 101 (formed by the outer housing) is substantially cylindrical and/or tubular. The seismic node may have a length to a diameter ratio of 4:1 or greater, such as approximately 5:1, 6:1, 7:1, 8:1, or greater. In one embodiment, the diameter may be approximately 6″ and the length may be approximately 60″. In one embodiment, seismic node 101 comprises a seismic node housing that is made of any variety of materials, such as aluminum, titanium, or plastic. Portions of the node housing may be metal, while portions of the node housing (such as the end caps) may be non-metallic such as a polymer. The housing may be a pressure resistant housing that is capable of withstanding water depths of 3000 meters or greater. It is a pressurized node housing, meaning that the pressurization is any measurable pressure above 0 psia. The node housing may be directly coupled or indirectly coupled (such as via a flexible tether) to anchor weight 123. The anchor weight facilitates free fall of the seismic node from the water surface to the bottom of the ocean, and helps the seismic node to stay coupled to the seabed. Tether 121 may be coupled to release assembly 119 of the seismic node, which may be on the inside or outside of the seismic node. The release assembly may be electronic or mechanical, and is configured to release the anchor weight from the seismic node at the appropriate time, such as when the seismic recording is finished and it is desired to retrieve the seismic node. In one embodiment, the release assembly is activated based on an acoustic signal. In one embodiment, there is only one release mechanism such that activation of the release mechanism releases the heavy weight anchor and coupled tether and the piece coupled to the seismic node to which the tether attaches. In one embodiment, releasing and/or de-coupling the anchor weight from the seismic node allows the seismic node to pop up and/or rise to the water surface for retrieval based on the positive buoyancy of the node itself. In one embodiment, a plurality of seismic nodes (such as hundreds or thousands) are stored on a surface vessel, and can be deployed from the surface to the seabed based on manual or automatic methods. In one embodiment, the anchor weights are attached to the node housing immediately prior to being deployed in the water. In one embodiment, when the seismic nodes are desired to be retrieved, the anchor weight is decoupled from the seismic node and the seismic node is able to rise or pop-up to the water surface for retrieval by the surface vessel. In one embodiment, the seismic node contains large internal volume 114 for buoyancy purposes, such that the seismic node itself is positively buoyant in water. In one embodiment, the anchor weight is configured to offset the positive buoyancy of the seismic node such that, when coupled to the seismic node, the seismic node and anchor weight is negatively buoyant to free fall to ocean bottom 103. In one embodiment, no external flotation device to the seismic node is required.

FIG . 1B is a schematic diagram illustrating another embodiment of an autonomous seismic node 101 according to the present disclosure. The embodiment in FIG. 1B is substantially similar to that as illustrated in FIG. 1A but for the anchoring mechanism. FIG. 1A includes a one part anchor system (the heavy anchor weight), while FIG. 1B includes a two part anchor system. In both embodiments, the seismic node is naturally self-buoyant, and is made negatively buoyant by coupling one or more anchor weights to the seismic node that provides an overall negative buoyancy to the node and assists in free fall of the seismic node to the seabed. Such anchor weights can be removably coupled to the seismic node via an indirect connection (such as a tether) or a direct attachment to the seismic node housing. In the embodiment of FIG. 1B, a first part of the anchor system comprises a light anchor weight and a second part comprises a heavy weight anchor. In this embodiment, heavy weight anchor 123 is coupled to lighter weight anchor 133 by tether 121, and lighter weight anchor 133 is directly attached to seismic node housing 101 via or proximate to release assembly 119. The lighter weight anchor helps to keep the node neutrally buoyant in the water, which may assist in seismic water coupling for better seismic recording. In one embodiment, there is only one release mechanism such that activation of the release mechanism releases the lighter weight anchor and the coupled heavy weight anchor and tether. When the seismic node is ready to be released from the seabed, all three parts (seabed anchor, tether, and light weight anchor) are left on the seabed. In one embodiment, an acoustic signal to the release assembly provides an electronic signal to the motor to release the tether (to detach the anchor). Similarly, an acoustic signal or time delay (or other mechanisms) can provide a signal to release the intermediate anchor for ascent. Release assembly 119 can attach to the anchor weight, baseplate, or tether using several methods such as a threaded interface, a spring loaded catch, an over center or sliding latch, or a fusible link or any combination thereof. A threaded interface may be preferential as it can be tightened to prevent the anchor weight, baseplate, or tether from moving relative to the node body and generating noise that could be picked up by the seismic sensor(s). A threaded interface on the release mechanism can use a small, low power motor coupled with a gear box to obtain adequate clamping force. A reciprocal threaded interface may be placed or attached to the anchor weight, baseplate, or tether, and the two parts tighten against each other during assembly outside of the water or on the back deck of the vessel.

In one embodiment, the node housing may contain electronics internally and externally to the housing, as is known in the art. On the upper end of the housing may be located various external acoustic devices and/or communication devices 111, such as a USBL transducer, antennae, hydrophones, and other connectors, as is known in the art. Within the housing may be located all of the electronic equipment, such as seismic recording devices 117 (geophones), PCB assemblies 113, battery packs 115, etc.

In one embodiment, the battery cells may be lithium-ion battery cells or rechargeable battery packs for an extended endurance (such as 90 days) on the seabed, but one of ordinary skill will recognize that a variety of alternative battery cell types or configurations may also be used. Additionally, the seismic node may include a pressure release valve configured to release unwanted pressure from the seismic node at a pre-set level. The valve protects against fault conditions like water intrusion and outgas sing from a battery package. Additionally, the seismic node may include an electrical connector configured to allow external access to information stored by internal electrical components, data communication, and power transfer. During the deployment the connector may be covered by a pressure proof watertight cap. In other embodiments, the node does not have an external connector and data is transferred to and from the node wirelessly, such as via electromagnetic or optical links.

In an embodiment, the internal electrical components may include one or more hydrophones, one or more (preferably three) geophones or accelerometers, and a data recorder. In an embodiment, the data recorder may be a digital autonomous recorder configured to store digital data generated by the sensors or data receivers, such as the hydrophone and the one or more geophones or accelerometers. One of ordinary skill will recognize that more or fewer components may be included in the seismic node. For example, there are a variety of sensors that can be incorporated into the node including and not exclusively, inclinometers, rotation sensors, translation sensors, heading sensors, and magnetometers. Except for the hydrophone, these components are preferably contained within the node housing that is resistant to temperatures and pressures at the bottom of the ocean, as is well known in the art.

In one embodiment, the seismic sensor may include one or more of a hydrophone, geophone, accelerometer, etc. For example, if a 4C (four component) survey is desired, the seismic sensors may include three geophones and a hydrophone, i.e., a total of four sensors. Alternatively, the seismic sensor may additionally include one or more accelerometers. Of course, other sensor combinations are possible, and may include one or more of a hydrophone, geophone, accelerometer, electromagnetic sensor, depth sensor, MEMs, Inertial Measurement Unit (IMU) or a combination thereof and which could be used together to measure up to six degrees of freedom. The seismic sensor may be located completely or partially inside body housing, while in some embodiments it may be located outside body housing when better water coupling/exposure is needed (e.g., for hydrophones). A memory unit may be connected to processor and/or seismic sensor for storing seismic data recorded by seismic sensor. A power system (such as one or more batteries) may be used to power all these components. The node may also include a clock and digital data recorder (not shown).

The seismic node may include a compass and other sensors as, for example, an altimeter for measuring its altitude, a pressure gauge, an interrogator module, etc. The node may optionally include an obstacle avoidance system and a communication device (e.g., Wi-Fi or other wireless interface, such as a device that uses an acoustic link) or other data transfer device capable of wirelessly transferring seismic data and/or control status data. One or more of these elements may be linked to processor. The seismic node may further include an antenna (which may be flush with or protrude from the housing) and a corresponding acoustic system for subsea communications. For surface communications (e.g., while the seismic node is on a ship), one or more of an antenna and communication device may be used to transfer data to and from the seismic node.

The seismic node systems may use an acoustic system as is known in the art. The acoustic system may be an Ultra-Short Baseline (USBL) system, also sometimes known as Super Short Base Line (SSBL) or Short Base Line (SBL) This system uses a method of underwater acoustic positioning. A complete USBL system may include a transceiver or acoustic positioning system mounted on a pole under a vessel or ROV (such as Hi-PAP or μPAP, commercially available by Kongsberg and Sonardyne) and a transponder on the seismic node. In general, a hydro-acoustic positioning system consists of both a transmitter and a receiver, and any Hi-PAP or μPAP or transponder system acts as both a transmitter and a receiver. An acoustic positioning system uses any combination of communications principles for measurements and calculations, such as SSBL. In one embodiment, the acoustic positioning system transceiver comprises a spherical transducer with hundreds of individual transducer elements. A signal (pulse) is sent from the transducer (such as a Hi-PAP or μPAP head on the surface vessel), and is aimed towards the seabed transponder located on the seismic node. This pulse activates the transponder on the seismic node, which responds to the vessel transducer after a short time delay. The transducer detects this return pulse and, with corresponding electronics, calculates an accurate position of the transponder (seismic node) relative to the vessel based on the ranges and bearing measured by the transceiver. In one embodiment, to calculate a subsea position, the USBL system measures the horizontal and vertical angles together with the range to the transponder (located in the seismic node) to calculate a 3D position projection of the seismic node relative to a separate station, basket, ROV, or vessel. An error in the angle measurement causes the position error to be a function of the range to the transponder, so an USBL system has an accuracy error increasing with the range. Alternatively, a Short Base Line (SBL) system, an inverted short baseline (iSBL) system, or an inverted USBL (iUSBL) system may be used, the technology of which is known in the art. For example, in an iUSBL system, the transceiver is mounted on or inside the seismic node while the transponder/responder is mounted on a separate vessel/station and the seismic node has knowledge of its individual position rather than relying on such position from a surface vessel (as is the case in a typical USBL system). In another embodiment, a long baseline (LBL) acoustic positioning system may be used. In a LBL system, reference beacons or transponders are mounted on the seabed around a perimeter of a work site as reference points for navigation. The LBL system may use an USBL system to obtain precise locations of these seabed reference points. Thus, in one embodiment, the reference beacon may comprise both an USBL transponder and a LBL transceiver. The LBL system results in very high positioning accuracy and position stability that is independent of water depth, and each seismic node can have its position further determined by the LBL system. The acoustic positioning system may also use an acoustic protocol that utilizes wideband Direct Sequence Spread Spectrum (DSSS) signals. In one embodiment, the seismic node is equipped with a plurality of communication devices, such as an USBL beacon capable of receiving and transmitting acoustic signals, a phased array receiver (or system) that is able to determine the direction of an incoming acoustic signal by analysis of the signal phase, and an acoustic modem.

Those skilled in the art would appreciate that more or less components and electronic devices may be added to or removed from the seismic node.

### Node Design

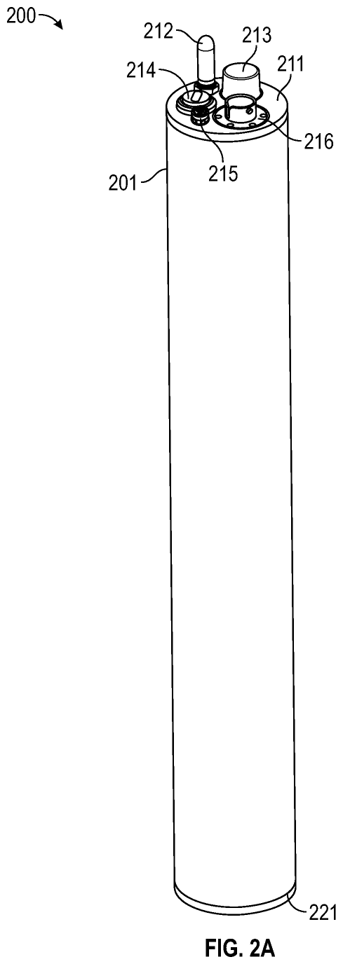

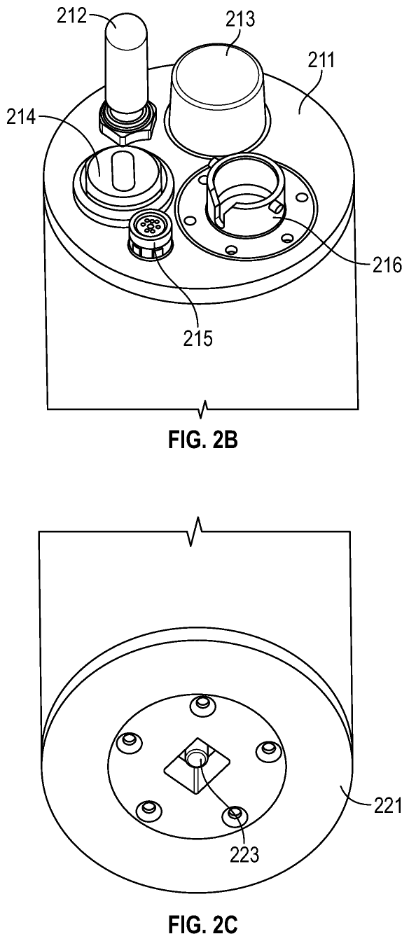

FIGS. 2A-2C illustrate perspective views of one embodiment of an autonomous seismic node according to the present disclosure. FIG. 2A illustrates a perspective view of seismic node 200 with seismic node housing 201, which may be substantially similar to the seismic node in FIG. 1A. Node 200 and node housing 201 is substantially cylindrical and/or tubular. In one embodiment, the seismic node and/or housing has a length to width ratio of at least 4:1, and in some embodiments may be up to approximately 10:1. FIG. 2B illustrates top end 211 of the node from FIG. 2A, while FIG. 2C illustrates bottom end 221 of the node from FIG. 2A. Each end is able to be screwed in and/or coupled to node housing 201 to obtain a water tight and pressure tight seismic node, which provides a pressurized node housing for the internal electronic components. As illustrated in FIG. 2B, a plurality of electronic devices is coupled to an upper end of the housing. For example, as discussed above, antenna 212, and acoustic device 213 may be located externally to the housing on the upper end of the housing. Other electronic devices may also be coupled to the upper end cap, such as pressure relief valve 215, electrical connector 216 for data transfer, and hydrophone 214. Such components are well known in the art. One or more devices may also be located on lower end 221 of the housing. As illustrated in FIG. 2C, release assembly 223 may be located on the lower end of the tubular housing, which may be coupled to an anchor weight (not shown). As detailed herein, release assembly 223 is configured to release a directly or indirectly coupled device, such as an anchor or tether.

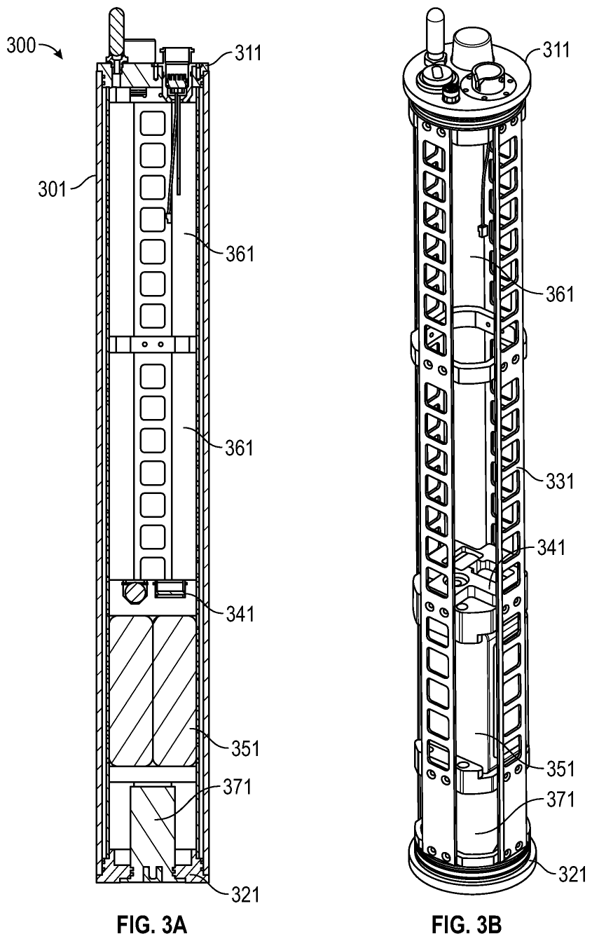

FIGS. 3A-3B illustrate an internal configuration of one embodiment of the autonomous seismic node from FIGS. 2A-2C. FIGS. 3A and 3B illustrate an internal side view and perspective view, respectively, showing upper end cap assembly 311 and lower end cap assembly 321 of node 300, as well as the remainder of the internal components. Similar to prior figures, lower cap assembly 321 houses geophone sensors 341 and main battery support assembly 351 (which houses the batteries) and release mechanism assembly 371. As illustrated, there is a sizeable open space section 361 between the upper end cap assembly and the lower end cap assembly, which provides internal volume and buoyancy for the seismic node. Each of these components will be discussed in more detail in the remaining figures. As illustrated in FIG. 3B, the seismic node 300 and seismic node housing 301 comprises internal support structure 331, to which internal components can be coupled within the seismic node housing. The internal support structure can be metallic or non-metallic, and may comprise one or more vertical sections extending the length of seismic node 300. In one embodiment, node housing 301 slides over support structure 331 and may be fastened, or otherwise mechanically coupled, to support structure 331. Node housing 301 may be substantially cylindrical and/or tubular, and may be formed of metallic or non-metallic material. In one embodiment, the lower and upper end caps are screwed and/or coupled to the ends of node housing 301, thereby forming seismic node 300.

In one embodiment, the node is designed to keep the center of buoyancy high in the seismic node and the center of gravity low. In this embodiment, the center of gravity (COG) is below the center of buoyancy (COB). In one embodiment, a positive buoyancy chamber is designed in the upper section of the node, while the battery packs and geophones are positioned in the bottom of the node. In one embodiment, the geophones are designed as close to the lower end cap as possible. In one embodiment, the geophones are velocity sensors, and the further away from the pivot point of the node, the larger the generated signal as a result of inadvertent movement, which could negatively impact the fidelity of the intended signal. Having the COB located above the COG ensures that the node descends the water column as vertically as possible such that the upper section of the node faces towards the water surface or sky during descent. The same trait is preferred when the node is released from the seafloor. When the nodes surfaces to the ocean surface, the wireless transponder located on the top cap should have a clear, un-obstructed view of the sky. The farther the COB is away from the COG, the more stable the node becomes. In one embodiment, the node's design and shape allows the nope to remain substantially vertical in the ocean bottom and near the ocean surface, which facilitates methods for the automated recovery of the nodes.

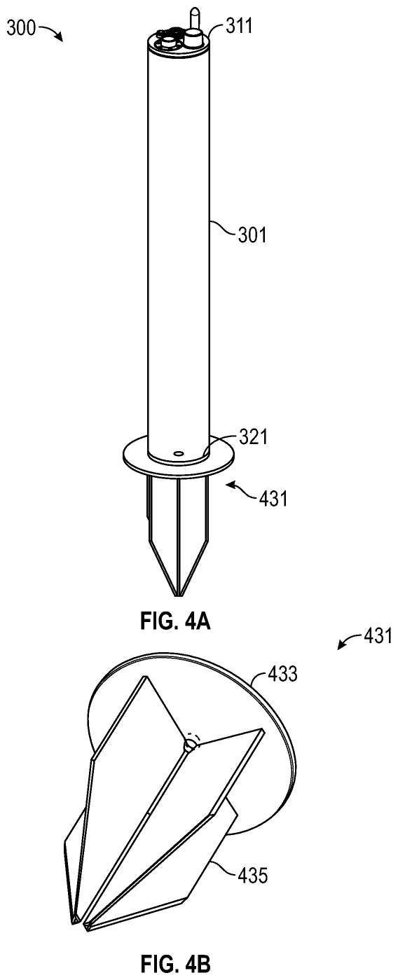

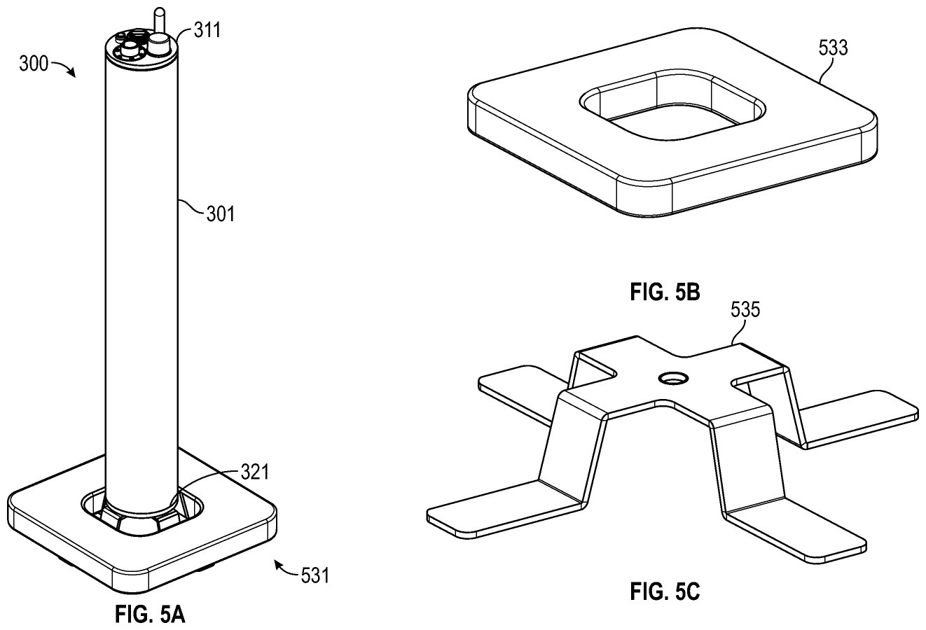

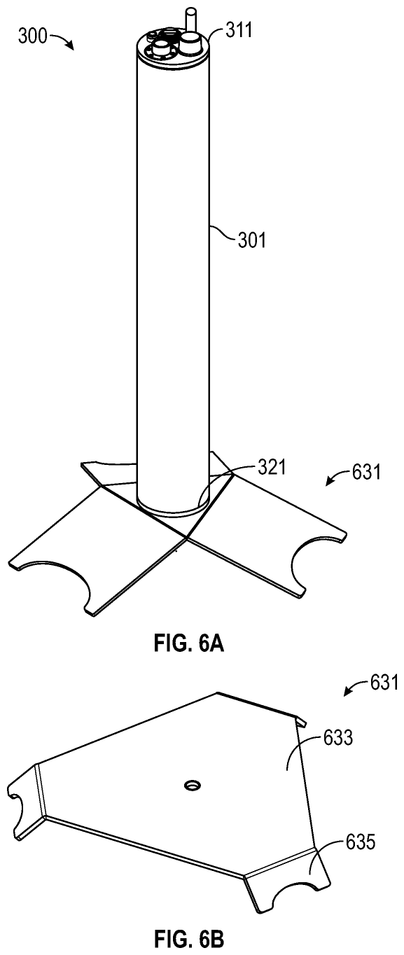

In one embodiment, the seismic node of FIGS. 2A and 3A may float and/or be offset from the seabed and still record seismic signals based on water coupling between the seismic sensor and the seabed, such as that illustrated in FIGS. 1A and 1B. In other embodiments, the seismic node (such as seismic node 300) may be coupled to the seabed for traditional 4C recording by attaching a node base to the bottom end of the tubular housing, which also acts as an anchor to assist in free fall. A wide variety of seabed coupling devices may be used. These seabed coupling devices may be a shaft, spear, or other penetrating device (see FIG. 4A-4B), while in other embodiments it may be a plate or base (see FIGS. 5A-5C and 6A-6B). The coupling devices can be mechanically coupled to the bottom of the node housing by a variety of mechanisms, including by a screw or other fastener. Similar to the releasable weight mechanism 119 of FIGS. 1A and 1B, the attachment of the base plate/seabed coupling device may be coupled to the same release assembly 119 or a similar release mechanism that is able to detach the seabed coupling device based on an acoustic signal and allow the seismic node to pop up and/or rise to the surface after seismic recording. The seabed coupling device also acts as a ballast weight that assists in free fall of the seismic node to the seabed.

In each of the embodiments illustrated in FIGS. 4A, 5A, and 6A, a seismic node 300 (substantially similar to that illustrated in FIGS. 3A and 3B), has a node housing 301 coupled to upper end cap 311 and lower end cap 321. FIGS. 4A-4B illustrate one embodiment of a seabed coupling device according to the present disclosure, which illustrates a pointed shaft attachment device 431 (see FIG. 4B) coupled to the seismic node housing. Shaft attachment 431 comprises a plurality of vertical ribs 435 that are cut at an angle and welded to round plate 433 for increased descent speed in the water and seabed penetration. In one embodiment, the penetrating device is made of iron or another metallic component, although non-metallic components are possible. FIGS. 5A-5C illustrate another embodiment of seabed coupling device 531 according to the present disclosure, which illustrates a plate coupled to the seismic node housing. FIG. 5B illustrates plate 533 of the seabed coupling device, which may be formed of metallic or non-metallic material, and in one embodiment is made of cement. As opposed to the angled shaft of FIG. 4B, the plate in FIG. 5B slows the descent of the seismic node in water. The plate may be coupled to the bottom of the seismic node housing via metal bracket 535 (see FIG. 5C). FIGS. 6A-6B illustrate another embodiment of seabed coupling device 631 according to the present disclosure, which illustrates a tripod plate/base coupled to the seismic node housing. FIG. 6B illustrates tripod base 633, which may be a heavy metallic (e.g., steel) material. In one embodiment, base 633 comprises angled wings or fins 635 extending from each corner of tripod base 633. The shape of the base helps control descent speed of the seismic node through water, and the high center of balance (COB) helps to keep the trajectory vertical in the water. The wide, low base ensures the node stays upright on seabed landing. In one embodiment, the seabed coupling devices are stored separately on the back of the marine vessel and can be attached to the seismic node prior to deployment into the ocean. In one embodiment, the plates in FIG. 5B, the brackets in FIG. 5C, and/or the base in FIG. 6B nest together for improved storage density on the back of the marine vessel. In one embodiment, the seabed coupling devices are made of a biodegradable material.

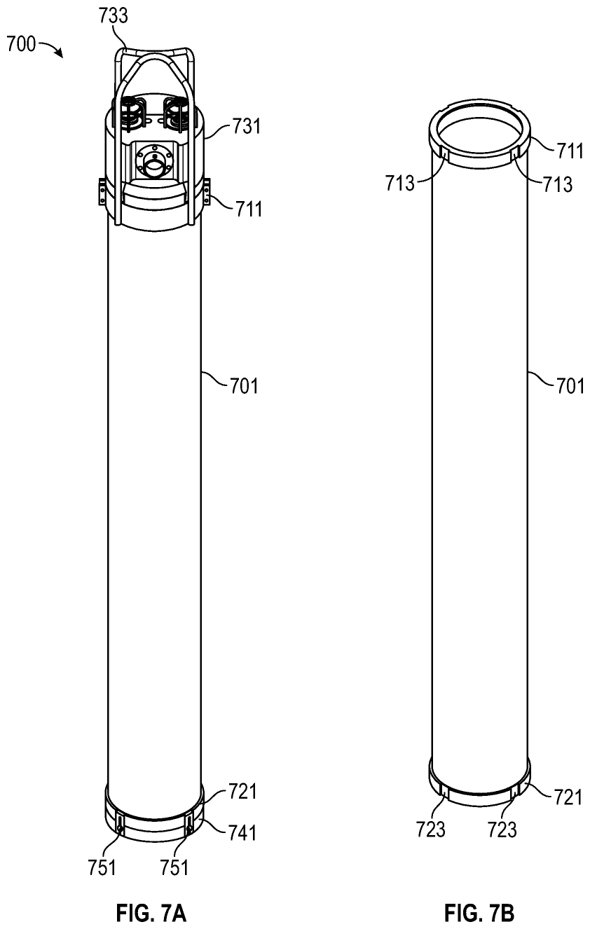

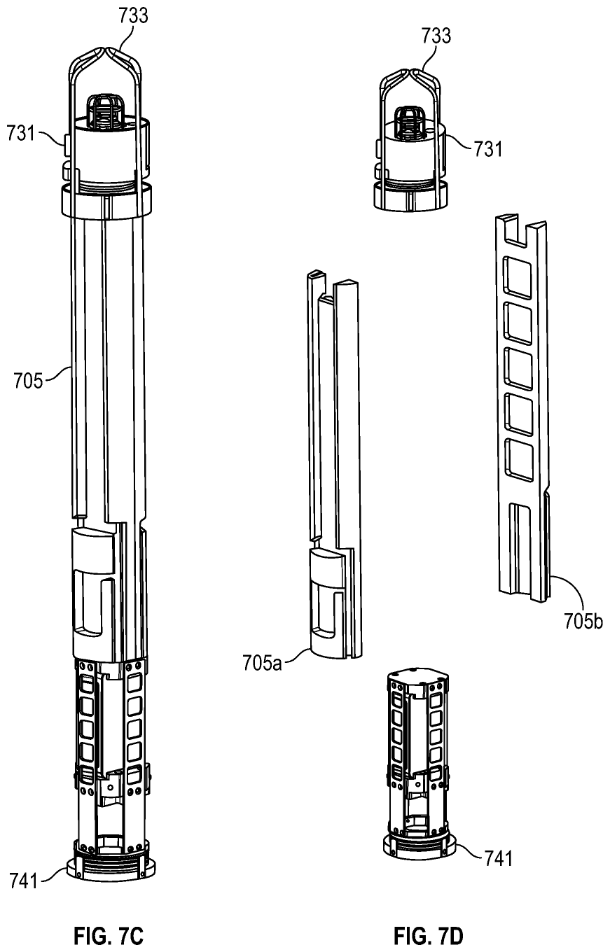

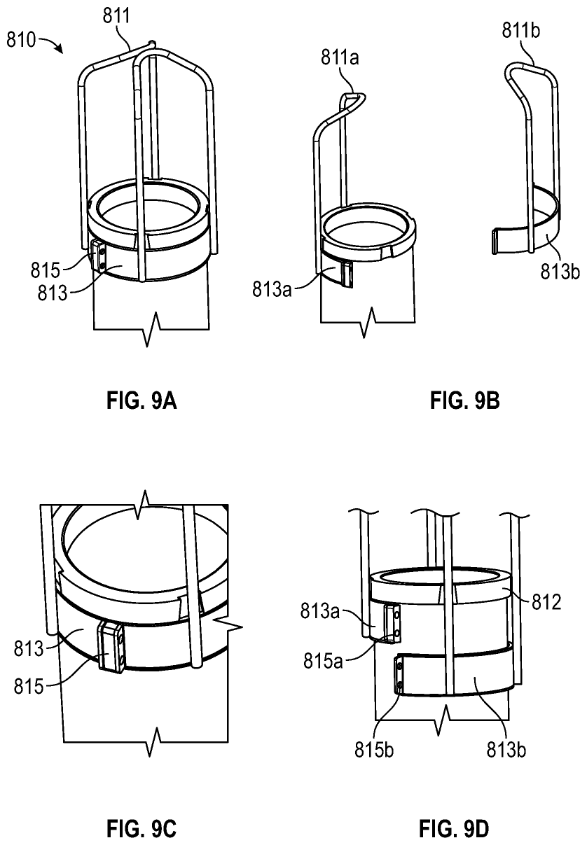

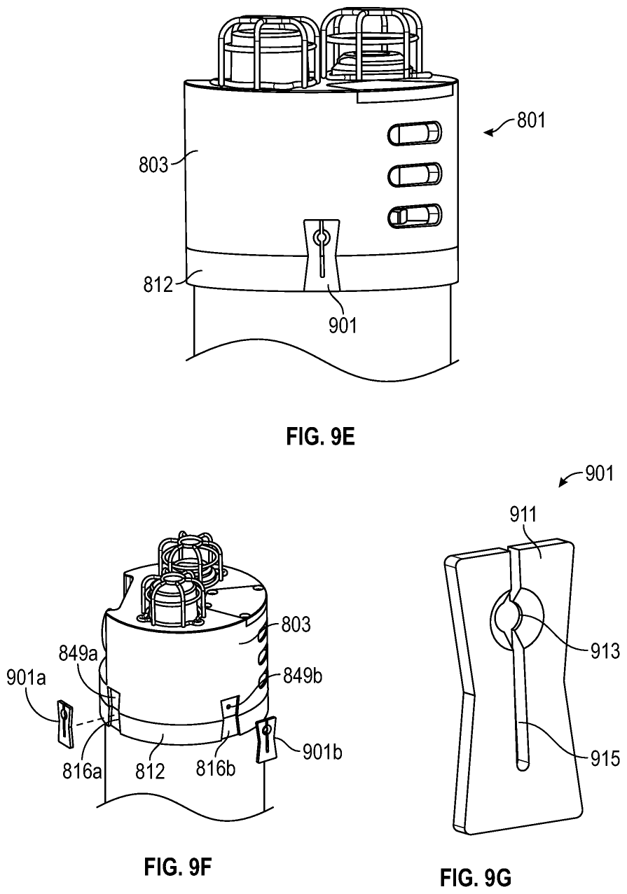

FIGS. 7A-7D illustrate one embodiment of autonomous seismic node 700 according to the present disclosure. The seismic node illustrated in FIG. 7A is substantially similar to FIGS. 2A and 3A, but illustrates a cage coupled to an upper endcap on the top section of the housing. As illustrated in FIG. 7A, seismic node 700 may comprise node housing 701 coupled to an upper endcap/section 731 and lower endcap/section 741. Upper endcap 731 may comprise a plurality of electronic components, as illustrated in FIG. 2A and other embodiments herein. Upper endcap may comprise or be coupled to cage 733, which allows handling of the seismic and protection of the electronic components on the upper end cap assembly. Node housing 701 may comprise and/or be coupled to upper flange 711 and lower flange 721, which allows fastening and/or coupling to the upper and lower endcaps. FIG. 7B illustrates tubular housing 701, to which an upper section 731 and lower section 741 may be coupled. In one embodiment, each of the lower and upper flanges 711, 721 and associated upper and lower sections/endcaps 731, 741 comprises a plurality of recesses 713, 723 that allows a separate fastening device (such as fastener/clip/wedge 751) to be inserted to secure the end caps to the node housing. Such clips are illustrated in more detail in FIGS. 9E-9G. In one embodiment, housing 701 is made of aluminum and has a thickness to withstand water pressures of about to 3000 meters or higher. FIG. 7C illustrates the seismic node of FIG. 7A with the outer housing (FIG. 7B) removed to show the internal configuration of the seismic node. Such components are described elsewhere herein. FIG. 7D illustrates a break-away of the interior assembly from FIG. 7C. The interior assembly comprises upper end cap 731 (with cage 733), lower cap assembly 741, and support insert 705 comprised of two parts, first part 705a and second part 705b. In one embodiment, support insert 705 may be molded and made from a polypropylene “foam” material or similar plastic, in which different pockets or recesses are molded to receive various electronic devices, such as batteries, transponders, modems, and other electronic devices. The plastic inserts may have different chase ways for wiring. In one embodiment, support structure 705 and the void space between the internal components of node housing 701 form a positive buoyancy to the seismic node.

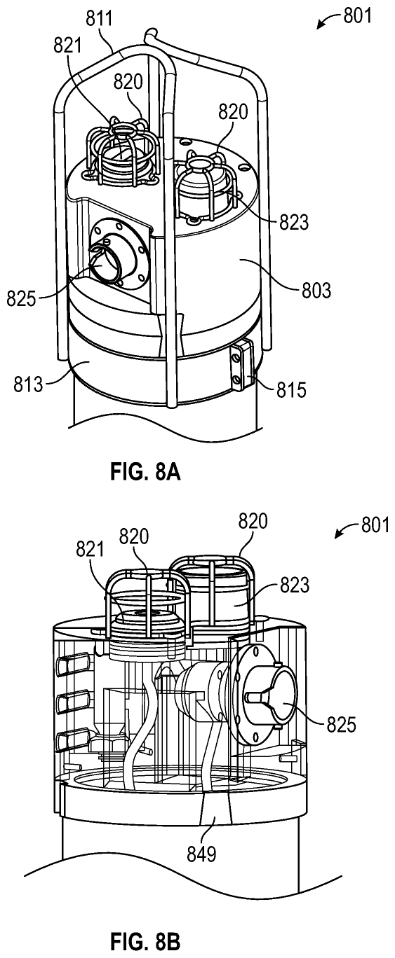

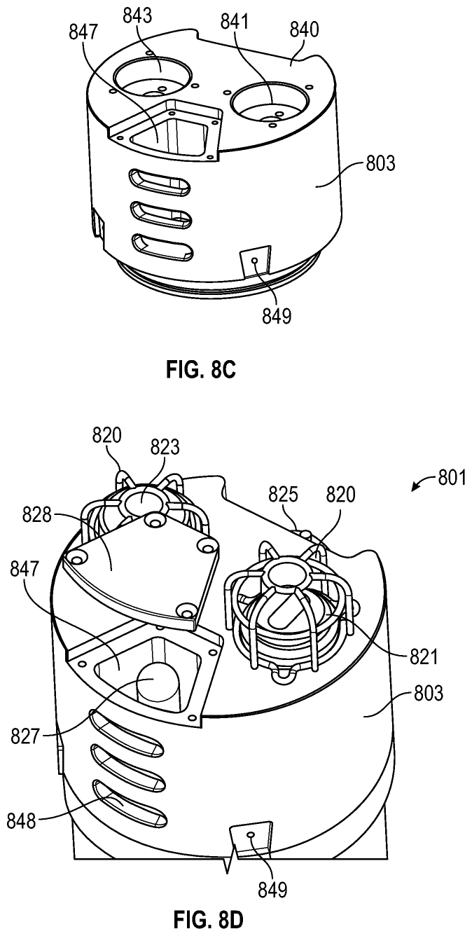

FIGS. 8A-8D illustrate one embodiment of upper end assembly 731 of the autonomous seismic node of FIG. 7A. FIG. 8A illustrates upper end cap 801 and detachable cage 811. Detachable lifting cage 811 protecting the upper end cap, the electronics on the upper end cap, and provides a lifting/handling point for the seismic node. In one embodiment, lifting cage 811 comprises a lower clamp assembly 813 with fastening mechanism 815. The detachable lifting cage is discussed in more detail in reference to FIGS. 9A-9D. FIG. 8B illustrates an internal configuration of upper end cap 801. FIG. 8C illustrates end cap 801 without the cage and electronic components as illustrated in FIG. 8A. FIG. 8D illustrates end cap 801 without the cage but with the electronic components illustrated in FIG. 8A. In one embodiment, upper end cap 801 comprises cap 803, which comprises a plurality of recesses or pockets 841, 843, 847 (see FIG. 8C) on an upper face 840 of the end cap to receive electronic components. In one embodiment, the electronic device is placed within the recess and secured into the recess from the bottom side of the end cap. For example, antenna 823 may be inserted in recess 843, acoustic transponder 821 may be inserted in recess 843, and hydrophone 827 may be inserted in recess 847. Recess 847 may be fitted with protective cap/plate 828 to protect hydrophone 847, with side openings 848 allowing water to couple with hydrophone 847 (see FIG. 8D). In one embodiment, a standard electronic connector 825 (such as a Transmark connector) may be utilized on the side of the upper end cap. Some of the electronic components that protrude from the cap assembly (such as an acoustic device or hydrophone) may have a component cage 820 that surrounds the electronic component to protect it. Such cages may be metallic or non-metallic, and may be coupled to cap 803 of end cap assembly 801. In one embodiment, the upper end cap has a primary cage 811 and each transducer has a secondary protection cage 820.

In one embodiment, upper end cap 803 can be a CNC machined component made from polymer, and may be formed by injection mold. Using a polymer based material eliminates and/or reduces corrosion issues. The upper end cap may be inserted into an open end of the seismic node housing (such as housing 701 from FIG. 7B). In one embodiment, end cap assembly comprises recess 849, which allows a separate clip or wedge or fastening mechanism to be inserted into the recess to couple the end cap to the seismic node housing (which has a corresponding recess). In one embodiment, upper end cap is coupled to the node housing via threads, but threads may not be necessary, as hydrostatic pressure in the water keeps the end caps in place with the housing. In one embodiment, two or more O-rings are placed around the end cap to help seal the end cap with the housing. Similar O-rings may be placed on a lower end cap (such as lower end cap assembly 221 in FIG. 2A). All electronic devices may have a plurality (such as two) O-rings for sealing concerns.

FIGS. 9A-9D illustrate a cage assembly for the upper end of the autonomous seismic node of FIG. 7A according to one embodiment of the present disclosure. In one embodiment, detachable cage assembly 810 acts as a protective cage as well as a lifting cage, and is substantially similar to the cage in FIG. 8A. Cage assembly 810 comprises protective cage 811 and clamp assembly 813 with fastening mechanism 815. As shown in FIGS. 9A and 9B, the primary protection of the upper end cap comes from a two-piece stainless steel cage. For example, FIG. 9B illustrates first cage part 811a and second cage part 811b, each with a corresponding clamp portion 813a and 813b. Each half of the cage may be welded together between a cage portion and the ring portion. A plastic ring (not shown) may protect the aluminum housing/tube from the steel collar assembly. The two halves of the cage may be bolted together, as shown in FIGS. 9C and 9D. Each clamp portion may have fastening mechanism 815a and 815b, which can be fastened together to secure the clamp assembly together and the clamp assembly to the seismic node housing. A plastic spacer block (item 815 in FIG. 9C) helps to ensure the proper clamping force is applied. In one embodiment (see FIG. 9D), an upper end of the node housing has a wider lip than the rest of the housing, which produces upper ring 812 that provides a back stop to support fastening of the upper top cap and the cage.

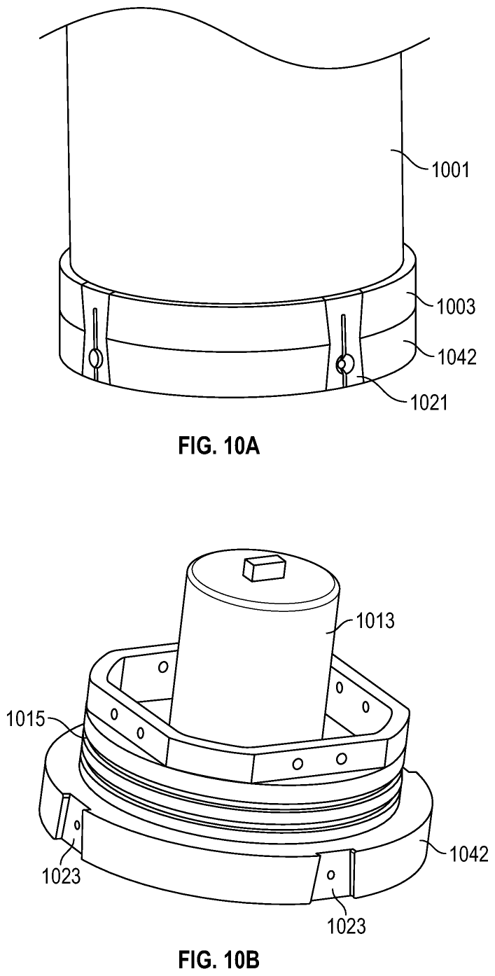

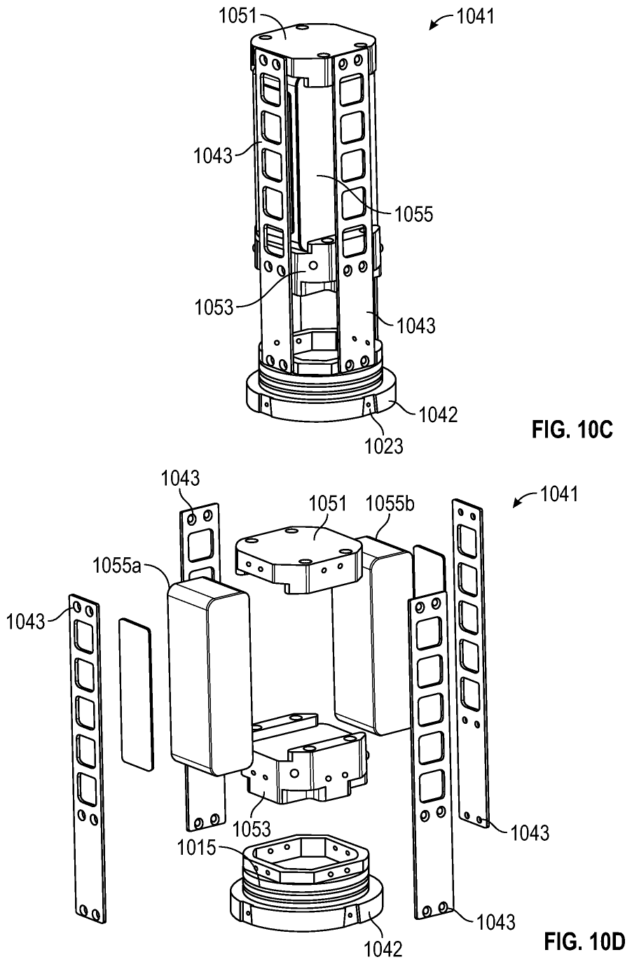

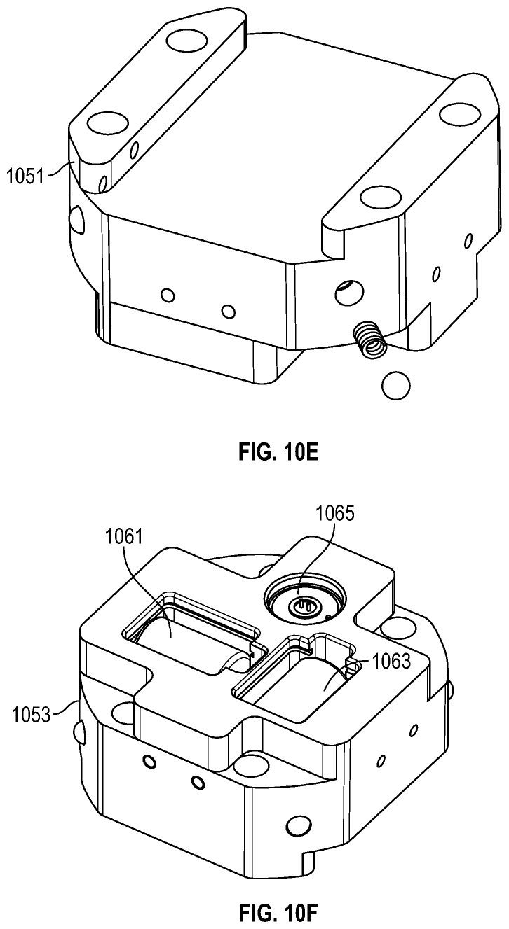

FIGS. 9E-9G illustrate the upper end of the autonomous seismic node of FIG. 7A according to one embodiment of the present disclosure, which is substantially similar to end cap assembly 801 in FIG. 8A. As shown in FIGS. 9E-9G, in one embodiment the upper end cap assembly is fastened together via a plurality of fasteners 901, which may be keys, clips, wedges, clips and/or dogbones. In one embodiment, clip 901 fits into a recess between housing lip 812 and upper end cap assembly 801. As illustrated in FIG. 9F, cap 803 comprises a first plurality of recesses 849 (849a, 849b, etc.), while lip 812 of the housing comprises a second plurality of recesses 816 (816a, 816b, etc.). A first portion of clip 901 fits within recess 849a, and a second portion of clip 901 fits within recess 816a. The plurality of clips, once installed, thereby secures the upper end cap assembly to the node housing. Likewise, similar clips and corresponding recesses can be used to couple the lower end cap assembly to the seismic node housing (see FIGS. 10A-10B). One embodiment of the fastener clip is illustrated in FIG. 9G. Clip 901 may be in the shape of a dogbone or dove tail wedge with a substantially flat front face 911. Clip face 911 may comprise screw hole 913 placed within slot 915. In one embodiment, a single flat head screw on each clip spreads the clip (by virtue of a slot through the clip) and locks it into the matching receptacle for a tight fit. The clip has a slim profile that allows it to be positioned fully within the recess so that it does not protrude past the outer edge of the housing/endcap assembly. The clip may be made of stainless steel or a high strength polymer.

FIGS. 10A-10F illustrate one embodiment of a lower end of the autonomous seismic node of FIG. 7A. As illustrated in FIG. 10A, seismic node housing 1001 may have a lower flange or ring 1003 at the bottom of the tubular housing. Lower end assembly 1041 (see FIG. 10C) has lower end cap flange 1042. Flange 1042 has a plurality of recesses 1023 for fasteners. When lower end cap assembly 1041 is inserted within the bottom of seismic node housing 1001, end cap flange 1042 abuts lower flange 1003 of the node housing (see FIG. 10A). Similar to FIGS. 9E-9G, clip 1021 may be positioned in recesses 1032 to securely fasten the lower end cap assembly to the node housing (see FIGS. 10A and 10B). In one embodiment, a plurality of clips 1021 securely fasten the lower end cap assembly to a lip of the tubular housing (see FIG. 10A), similar to how the upper end cap assembly is coupled to the upper section of the tubular housing (see FIG. 9E). In one embodiment, threads are not utilized to insert the end caps into the node housing. In one embodiment, two or more O-rings 1015 are placed around the end cap to help seal the end cap with the housing. In one embodiment, the hydrostatic pressure helps seal the lower end cap assembly and upper end cap assembly into the housing without the need for threads. In one embodiment, an electric motor and/or release assembly 1013 (see FIG. 10B) is integrated into the lower end cap assembly, which allows an anchor weight or seabed coupling device or tether to be detached from the seismic node. As shown in FIG. 10C and FIG. 10D, the lower assembly of the seismic node is built into the lower end cap assembly. The lower assembly comprises support structure 1043 that couple the lower end cap flange 1042 to the rest of the electronic components within the lower assembly. In one embodiment, the support structure 1043 comprises four aluminum struts that hold and secure the machined plastic blocks together (see FIG. 10D). In one embodiment, FIGS. 10E and 10F illustrate the support block. Battery pack system 1055 is positioned between upper block 1051 and lower block 1053, each of which are coupled to support structures 1043. Multiple battery sections 1055a, 1055b may be utilized. Lower block 1053 serves as both the geophone block and the main battery 1055 support block. Lower block 1503 may comprise a plurality of recesses, each of which holds an electronic component, such as geophones 1061, 1063, and 1065. The support blocks permit wiring to pass between the different layers via various holes in the support blocks. The support blocks can be made of plastic and formed by injection molding techniques.

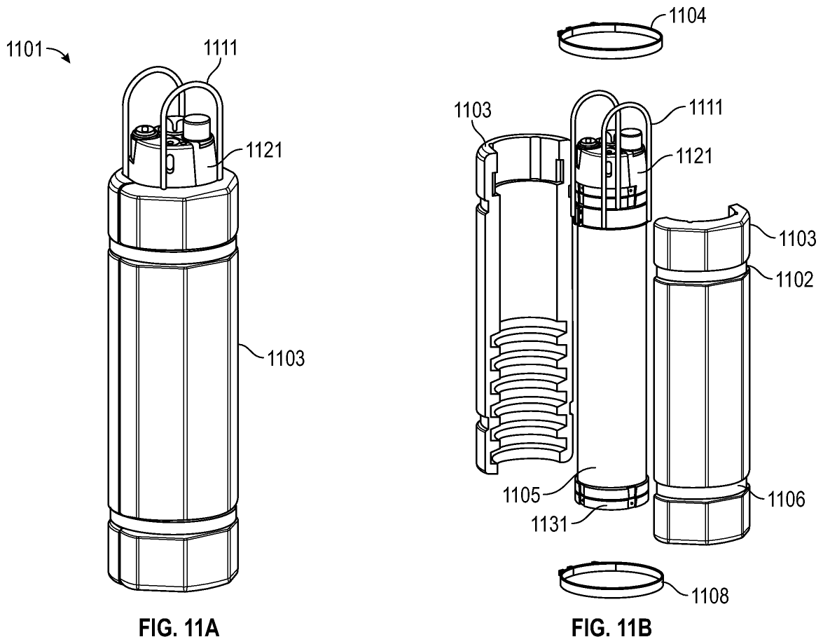

FIGS. 11A-11B illustrate one embodiment of an autonomous seismic node with a flotation jacket according to the present disclosure. This seismic node may be substantially similar to that described in FIGS. 2A, 3A, and 7A. In one embodiment, seismic node 1101 comprises node housing 1105, upper end cap assembly 1121, lower end cap assembly 1131, detachable lifting cage 1111, and flotation jacket 1103. In one embodiment, flotation jacket 1103 comprises two parts that substantially enclose the seismic node housing. The flotation jacket may comprise a plurality of recesses 1102, 1106 in which a plurality of clamps or rings 1104, 1108 may be inserted to securely fasten the flotation jacket around the seismic node housing. In other embodiments, the flotation jacket may comprise more parts or just one part, in which the jacket may slip over the tubular section from one end. The flotation jacket provides additional buoyancy to the seismic node. In one embodiment, the combination of the seismic node housing and the flotation jacket is positively buoyant in water, whereas in other embodiments the combination of the seismic node housing and the flotation jacket is neutrally buoyant in water.

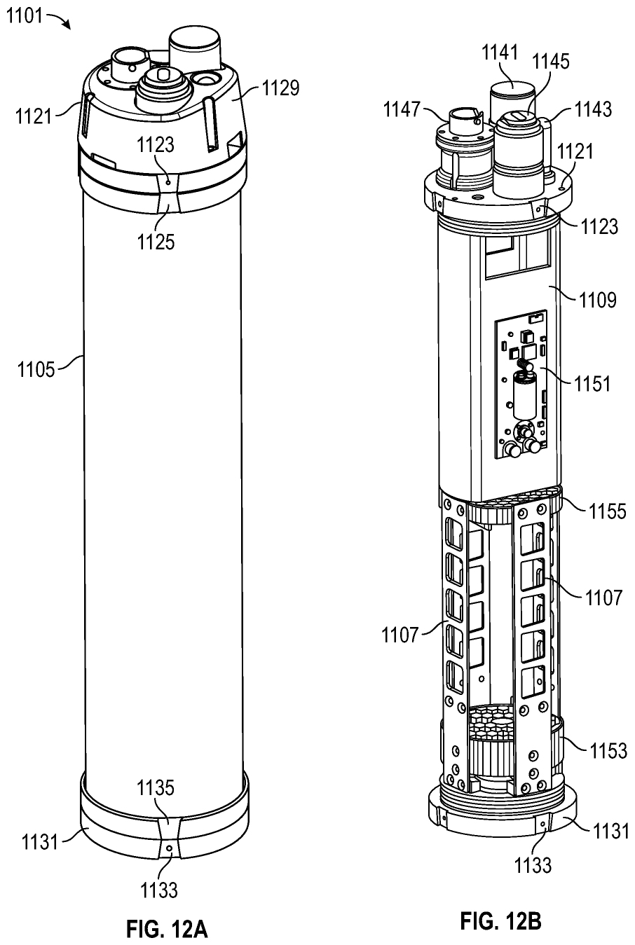

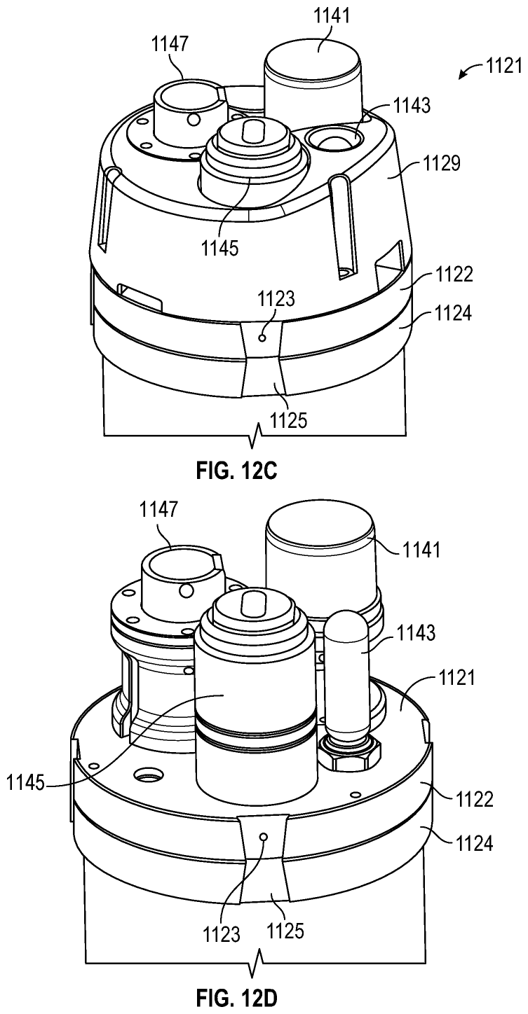

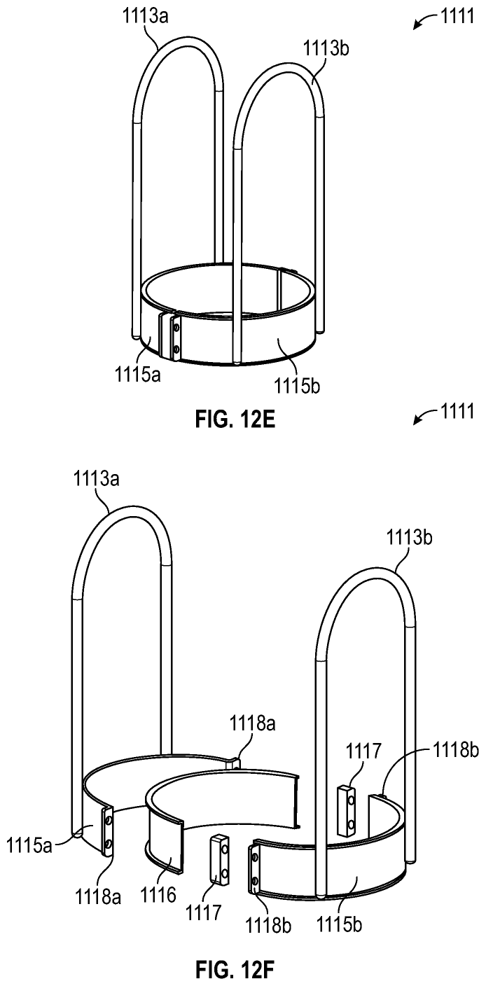

FIGS. 12A-12F illustrate multiple views of one embodiment of the autonomous seismic node from FIGS. 11A-11B but without the flotation jacket. This seismic node embodiment may be substantially similar to that described in FIGS. 2A, 3A, and 7A. In one embodiment, seismic node 1101 comprises node housing 1105, upper end cap assembly 1121, and lower end cap assembly 1131. Protective cap 1129 is fastened to the end cap assembly and helps protect the electronic components protruding from the end cap assembly. An upper flange on the seismic node housing comprises recess 1125 that is adjacent to recess 1123 on upper end cap assembly Likewise, a lower flange on the seismic node housing comprises recess 1135 that is adjacent to recess 1133 on lower end cap assembly. The recesses are configured for insertion of a clip (see FIGS. 9E-9G) to secure the seismic node housing to the lower and upper end cap assemblies. In one embodiment, a support structure extends from the lower end cap assembly to the upper end cap assembly. In another embodiment, as shown in FIG. 12B, a lower support structure 1107 is coupled to the lower end cap assembly, and a separate upper support structure or electronic housing 1109 is coupled to the upper end cap assembly. Both the upper and lower sections may be coupled together separately or may fit within the node housing via fastening the end cap assemblies to the node housing. An internal buoyancy chamber exists inside the node housing, which may be simply the space between the components inside the housing. As long as the water displaced by a void section weighs more than the section itself, it may be considered a buoyancy chamber. FIGS. 12C and 12D illustrate end cap assembly 1121 with and without protective cap 1129. As described herein, end cap assembly has flange 1122 with recess 1123, and seismic node housing 1105 has flange 1124 with recess 1125. When recesses 1123 and 1125 are aligned, a corresponding clip can be positioned within the recesses to secure the two flanges together. A plurality of such recesses may be positioned around the circumference of the flanges.

FIG. 12B illustrates seismic node 1101 with the seismic node housing 1105 removed for illustrative purposes. Further, as compared to FIG. 12A, protective block 1129 is removed from end cap assembly 1121. Electronic components may protrude from the end cap assembly with watertight connections. For example, acoustic transponder 1141, antenna 1143, hydrophone 1145, and electronic connector 1147 may be utilized, as is well known in the art. More or less electronic components may be utilized. One side of the electronic components is exposed to water and pressure conditions (which must withstand seabed depths), while the other side is within the pressurized node housing and is connected via wires to internal electronic components. For example, the seismic node may have a power system (such as battery packs), seismic sensors (such as geophones), data recorders, etc. The node may comprise one or more PCB sections 1151, which is an electronic PCB for the data recorded and/or the acoustic system. The node may comprise support structure 1155 that is used to hold the batteries in place and to support the structure above which contains the electronic PCB section. The node may comprise geophone block 1153 which is used to hold the seismic sensors (geophones) securely within the node housing.

A detachable lifting cage 1111 is illustrated in FIGS. 12E and 12F. This is similar to the cage illustrated in FIGS. 9A-9D. In one embodiment, cage 1111 comprises two cage sections that clamp together around a portion of the upper end cap assembly. In one embodiment, cage 1111 comprises first cage section 1113a which is coupled to second clamp section 1115a and second cage section 1113b which is coupled to second clamp section 1115b. Each clamp section is hemispherical in shape. Cage portions 1113a and 1113b provide protection to the protruding electronic components and allows a user (or robot) to handle the seismic nodes. In one embodiment, each clamp portion comprises a fastening mechanism on each end of the clamp, which is configured to attach to corresponding fastening mechanisms on the other clamp. In one embodiment, clamp fastener 1118a is coupled to clamp fastener 1118b with spacer 1117. Ring portion 1116 may be utilized on the inside of the clamp to prevent abrasion and resultant corrosion between the metallic cage and the node housing.

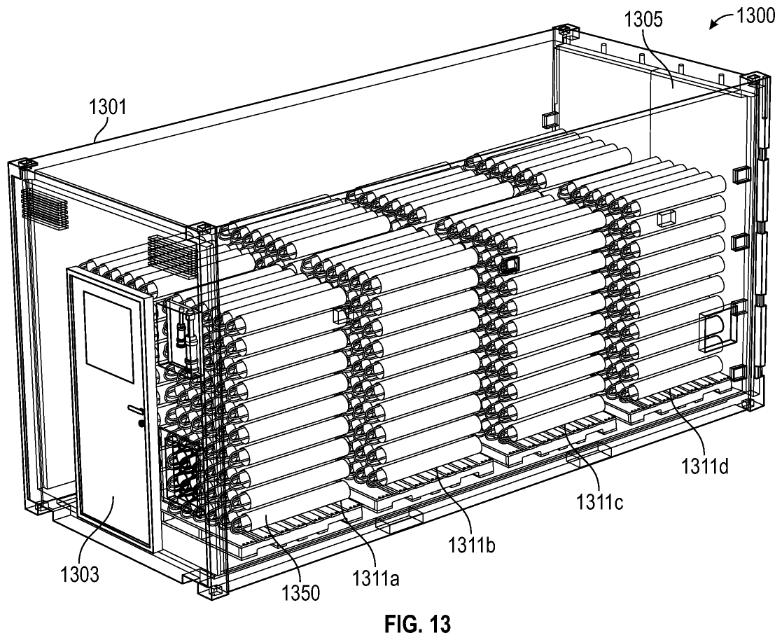

FIG. 13 illustrates one embodiment of a storage system 1300 for a plurality of autonomous seismic nodes according to one embodiment of the present disclosure. Seismic nodes 1350 may be substantially similar to that described herein. The seismic nodes may be arranged on a plurality of racks in a plurality of rows 1311a, 1311b, etc., which may be located in a standardized shipping container on the back deck of a marine vessel, which may be a 20 foot or 40 foot length container. In one embodiment, the seismic nodes are arranged horizontally within container 1301 on one or more pods. The container may have a door 1303 on one side of the container and one or more doors 1305 on the other side of the container. In one embodiment, the floor of the container comprises rollers (not shown), on which the pods of seismic devices may be rolled in and out of the container. In one embodiment, 400 nodes or more can be stored in a single container; if 1600 nodes are needed for a seismic survey, 4 containers (of 400 seismic nodes each) may be utilized on the back of the marine vessel. In one embodiment, seismic nodes are stacked 10 high by 6 wide, with each column having approximately 60 seismic nodes. In one embodiment, as illustrated in FIG. 13, approximately 8 columns of racks of nodes can be stored within a single container.

In one embodiment, disclosed is a method for deploying a plurality of autonomous seismic nodes to the seabed. In one embodiment, the method comprises providing a seismic node on a back deck of a marine vessel, coupling an anchor weight to the node housing while the seismic node is on the back deck of the marine vessel, and deploying the seismic node with the coupled anchor weight from the surface vessel to the bottom of the ocean by allowing the node to free fall and/or descend on its own to the bottom of the seabed because of the coupled anchor weight. The method may further comprise coupling the anchor weight to the bottom of the ocean and retrieving the node housing from the bottom of the ocean. In one embodiment, the method may further comprise releasing the anchor weight from the node housing based on an acoustic signal and surfacing the node housing near a surface of a body of water. In one embodiment, the seismic node is substantially similar to the nodes described herein. For example, the seismic node may comprise a pressurized node housing, wherein at least one seismic sensor, at least one data recording unit, and at least one clock are located within the pressurized node housing, wherein the node housing is substantially tubular and has a length to a diameter ratio of 4:1 or greater.

Many other variations in the overall configuration of the node, node housing, anchor weight, and seabed coupling device are possible within the scope of the invention. For example, the node itself may be positively buoyant by itself and/or with a buoyant flotation jacket. The node may or may not use a detachable lifting cage. All or some of the components left on the seabed may be biodegradable or environmentally friendly. The nodes may be dropped from a marine surface vessel or an underwater ROV. The diameter of the tube may range between 3″ to 12″, and the length of the tube may range from 12″ to 96″. Portions of the node may be metallic or non-metallic, including the pressurized node housing. Clips and/or fasteners may or may not be used to couple the end caps to the node housing. It is emphasized that the foregoing embodiments are only examples of the very many different structural and material configurations that are possible within the scope of the present invention.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

What is claimed is:

1. An autonomous seismic node for deployment to the seabed, comprising:
a pressurized node housing, wherein at least one seismic sensor, at least one data recording unit, and at least one clock are located within the pressurized node housing,
wherein the node housing is substantially tubular and has a length to a diameter ratio of 4:1 or greater.

2. The seismic node of claim 1, wherein the node housing has a length to diameter ratio of 8:1 or greater.

3. The seismic node of claim 1, wherein the node housing comprises a center of gravity and a center of buoyancy, wherein the center of gravity is below the center of buoyancy.

4. The seismic node of claim 1, wherein the node housing comprises an internal buoyancy chamber.

5. The seismic node of claim 1, wherein the seismic node is positively buoyant.

6. The seismic node of claim 1, further comprising a detachable lifting cage coupled to an upper section of the node housing.

7. The seismic node of claim 1, wherein the seismic node further comprises
an upper section of the node housing;
a lower section of the node housing;
an upper end cap assembly coupled to the upper section via a first plurality of clips; and
a lower end cap assembly coupled to the lower section via a second plurality of clips.

8. The seismic node of claim 7, wherein each of the first and second plurality of clips is substantially flat.

9. The seismic node of claim 7, wherein each of the first plurality of clip fits within a first plurality of corresponding recesses on the upper section and the upper end cap assembly and the second plurality of clip fits within a second plurality of corresponding recesses on the lower section and the lower end cap assembly.

10. The seismic node of claim 7, wherein the upper end cap assembly is coupled to a hydrophone, an acoustic transducer, a satellite transducer, and an electronic connector.

11. The seismic node of claim 7, wherein the lower cap assembly comprises a release mechanism for a detachable anchor weight.

12. The seismic node of claim 7, wherein at least one of the upper and lower end cap assemblies comprise a polymer material.

13. The seismic node of claim 1, further comprising at least one detachable anchor weight that is configured to be released from the seismic node by an acoustic signal.

14. The seismic node of claim 13, wherein the seismic node is positively buoyant in water, wherein the at least one anchor weight is negatively buoyant in water, wherein the combination of the seismic node and the at least one anchor weight is negatively buoyant in water.

15. The seismic node of claim 13, wherein the at least one anchor weight is coupled to the node housing via a flexible tether.

16. The seismic node of claim 13, wherein the at least one anchor weight is directly coupled to the node housing.

17. The seismic node of claim 13, wherein the at least one anchor weight comprises a first anchor weight and a second anchor weight, wherein the first anchor weight is directly attached to the node housing, wherein the second anchor weight is coupled to the first anchor weight via a tether, wherein the first anchor weight is positioned between the seismic node and the second anchor weight, wherein the first and second anchor weights can be released from the seismic node by an acoustic signal.

18. The seismic node of claim 17, wherein the second anchor weight couples to the seabed.

19. The seismic node of claim 17, wherein the combination of the seismic node and the first anchor weight is approximately neutrally buoyant in water.

20. The seismic node of claim 17, wherein the combination of the seismic node, the first anchor weight, and the second anchor weight is negatively buoyant in water.

21. The seismic node of claim 1, further comprising a flotation jacket configured to substantially surround the seismic node housing.

22. The seismic node of claim 19, wherein the combination of the seismic node housing and the flotation jacket is positively buoyant in water.

23. The seismic node of claim 1, wherein the seismic node comprises a positively buoyant section and a negatively buoyant section, wherein the negatively buoyant section is removably detached from the positively buoyant section.

24. An autonomous seismic node for deployment to the seabed, comprising:
a pressurized node housing, wherein at least one seismic sensor, at least one data recording unit, and at least one clock are located within the pressurized node housing; and
an anchor weight removably attached to a lower section of the node housing,
wherein the node housing is substantially tubular and has a length to a diameter ratio of 4:1 or greater.

25. The seismic node of claim 24, wherein the anchor weight is coupled to the node housing via a flexible tether.

26. The seismic node of claim 24, wherein the anchor weight comprises a seabed coupling device that is directly coupled to the node housing.

27. The seismic node of claim 26, wherein the seabed coupling device comprises a plate.

28. The seismic node of claim 26, wherein the seabed coupling device comprises a tripod base.

29. The seismic node of claim 26, wherein the seabed coupling device comprises a ribbed spear.

30. The seismic node of claim 26, wherein the seabed coupling device comprises an open-ended pipe base.

31. The seismic node of claim 24, wherein the anchor weight comprises a biodegradable material.

32. The seismic node of claim 24, wherein the anchor weight is configured to be released from the seismic node by an acoustic signal.

33. A method for deploying an autonomous seismic node to the seabed, comprising:
providing a seismic node on a back deck of a marine vessel, wherein the seismic node comprises a pressurized node housing, wherein at least one seismic sensor, at least one data recording unit, and at least one clock are located within the pressurized node housing, wherein the node housing is substantially tubular and has a length to a diameter ratio of 4:1 or greater;
coupling an anchor weight to the node housing while the seismic node is on the back deck of the marine vessel; and
deploying the seismic node with the coupled anchor weight from the surface vessel to the bottom of the ocean by free-fall of the seismic node.

34. The method of claim 33, further comprising coupling the anchor weight to the bottom of the ocean.

35. The method of claim 33, further comprising retrieving the node housing from the bottom of the ocean.

36. The method of claim 33, further comprising releasing the anchor weight from the node housing based on an acoustic signal and surfacing the node housing near a surface of a body of water.
